(19) United States
(12) Patent Application Publication
(10) Pub. No.: US 2002/0000789 A1
(43) Pub. Date: Jan. 3, 2002

(54) Charger assembly

(76) Inventor: Chaz G Haba, North Hills, CA (US)

Correspondence Address: John G Chupa, Chupa & Alberti PC, 31313 Northwestern Highway, Suite 205, Farmington Hills, MI, 48334, US

(21) Appl. No.: 09/557,058

(22) Filed: Apr. 21, 2000

(51) Int. Cl. H02J 7/00

(52) U.S. Cl. 320/128

(57) ABSTRACT

A charger assembly 10 for use with a battery assembly 22. Charger assembly 10 includes a member 50 which is selectively and removably insertable into a conventional electrical power outlet, effective to allow electrical power to be communicated to the charger assembly 10. The communicated electrical power is selectively transferred to the battery assembly 22, effective to substantially and fully charge the battery assembly 22 in a manner which substantially reduces the likelihood of overcharging and in a manner which selectively allows a “float” voltage or “trickle charge” to be provided to the battery assembly 22.

### (1) FIELD OF THE INVENTION

This invention relates to a charger assembly and more particularly to an assembly which selectively communicates electrical power to a battery assembly effective to electrically charge the battery assembly.

### (2) BACKGROUND OF THE INVENTION

Charger assemblies are generally used to allow electrical power to be communicated from an electrical power source to a battery assembly (i.e. one or more batteries), effective to allow the battery assembly to be electrically charged and to thereafter allow the charged battery assembly to provide the stored charge and power to many diverse types of devices and apparatuses in order to allow these devices and apparatuses to operate.

While it is desirable to fully and completely charge such a battery assembly, it is concomitantly and also highly desirable to substantially and automatically ensure that the battery assembly is not overcharged (i.e. that the battery assembly does not receive a voltage and/or an amount of electric charge exceeding the maximum threshold limit of the assembly) in order to avoid damage to the battery assembly and “out gassing” of the charge transport medium within the battery assembly. While many chargers do allow a battery assembly to be fully charged, they do not adequately prevent such overcharging or rely upon the user or the operator to determine whether a complete charge has been communicated to the battery assembly. These prior charges therefore fail to adequately ensure that such a complete charge has been communicated to the battery assembly while concomitantly and substantially preventing such undesirable overcharging.

It is also highly desirable to selectively provide either a “trickle charge” or a “float charge” to the battery assembly while the battery assembly is not “in use” (i.e., providing electrical power) and or to automatically “recharge” the battery assembly after a certain amount of time of “non-use” has expired in order to substantially prevent the battery from electrically discharging. The selective use of these “dual functions” (i.e., trickle charging and/or automatic recharging) allows the charger to remain operatively connected to the battery assembly during periods of non-use or to be later connected to the charger prior to the needed “recharge”, thereby allowing a single charger to be operatively used in combination with several battery assemblies while automatically “recharging” a previously charged battery assembly after a certain period of time has passed. Many prior charge assemblies do not adequately provide such a “float charge” and/or do not allow the selective use of such trickle charge or automatic “recharge” functionality.

It is also highly desirable to allow the charger to automatically “recognize” the amount and type of electrical power which it receives and to adapt the charger for operation with a wide variety of diverse types of voltages, currents, and power, thereby increasing its overall utility and substantially reducing the likelihood of operator error or operator induced malfunction.

Prior chargers do not typically operate with a wide variety of received and diverse voltages, currents, and/or electrical power and do not typically and automatically recognize such received voltages, currents, and power. Rather, these prior chargers require the operator to recognize the type and/or value of these received voltages, currents, and power and provide this information to the charger or to simply “not use” the charger with such improper input signals, thereby increasing the likelihood of operator error or operator induced malfunction and undesirably increasing the complexity of the overall electrical charging process.

There is therefore a need for a new and improved charger assembly which overcomes some or all of the previously delineated drawbacks of prior charger assemblies. Accordingly, as is more fully and completely delineated below, the present invention addresses these drawbacks and provides and/or constitutes a new and improved charger assembly which is relatively lightweight, relatively inexpensive, relatively compact, and relatively uncomplicated and which is adapted to be selectively and remotely queried.

### SUMMARY OF THE INVENTION

It is a first object of the present invention to provide a charger assembly which overcomes some or all of the previously delineated drawbacks of prior charger assemblies.

It is a second object of the present invention to provide a charger assembly which overcomes some or all of the previously delineated drawbacks of prior charger assemblies and which substantially reduces the likelihood of overcharging a battery assembly while allowing the battery assembly to be substantially, fully, and electrically charged.

It is a third object of the present invention to provide a charger assembly which overcomes some or all of the previously delineated drawbacks of prior charger assemblies and which further and selectively provides a “trickle charge” to a battery assembly, thereby substantially preventing discharge of the battery assembly during non-use.

It is a fourth object of the present invention to provide a charger assembly which overcomes the various and previously delineated drawbacks of prior charger assemblies and which selectively and periodically communicates electrical charge to a battery assembly while being relatively inexpensive, lightweight, uncomplicated, and relatively compact.

It is a fifth object of the present invention to provide a charger assembly which overcomes the various and previously delineated drawbacks of prior charger assemblies and which receives electrical current, voltage, and power of a certain type and which automatically recognizes the certain type and which provides a substantially constant output signal which is independent of the certain type of electrical current, voltage, and power which it has received.

According to a first aspect of the present invention a charger assembly is provided and is used in combination with a battery assembly having a certain maximum voltage threshold value. The charger assembly receives electrical voltage and communicates the received voltage to the battery assembly only if the electrical voltage is below the threshold value.

According to a second aspect of the present invention a charger assembly is provided and is used in combination with a battery assembly having a certain maximum charge threshold value. The charger assembly receives electrical charge and communicates the received electrical charge to the battery assembly only if the electrical charge of the battery assembly is below the maximum threshold valve.

According to a third aspect of the present invention a charger assembly is provided for use in combination with a battery assembly. The charger assembly charges the battery assembly and continues to provide electrical charge to the battery assembly after the battery has been charged.

According to a fourth aspect of the present invention a charger assembly is provided, and communicates voltage to a battery assembly, the voltage being dynamically modified to substantially prevent overcharging of the battery assembly.

These and other features, aspects, and advantages of the present invention will become apparent from a reading of the following detailed description of the preferred embodiment of the invention and by reference to the following drawings.

### BRIEF DESCRIPTION OF THE DRAWINGS

FIG. 1 is a block diagram of a charger assembly which is made in accordance with the teachings of the preferred embodiment of the invention.

### DETAILED DESCRIPTION OF THE PREFERRED EMBODIMENT OF THE INVENTION

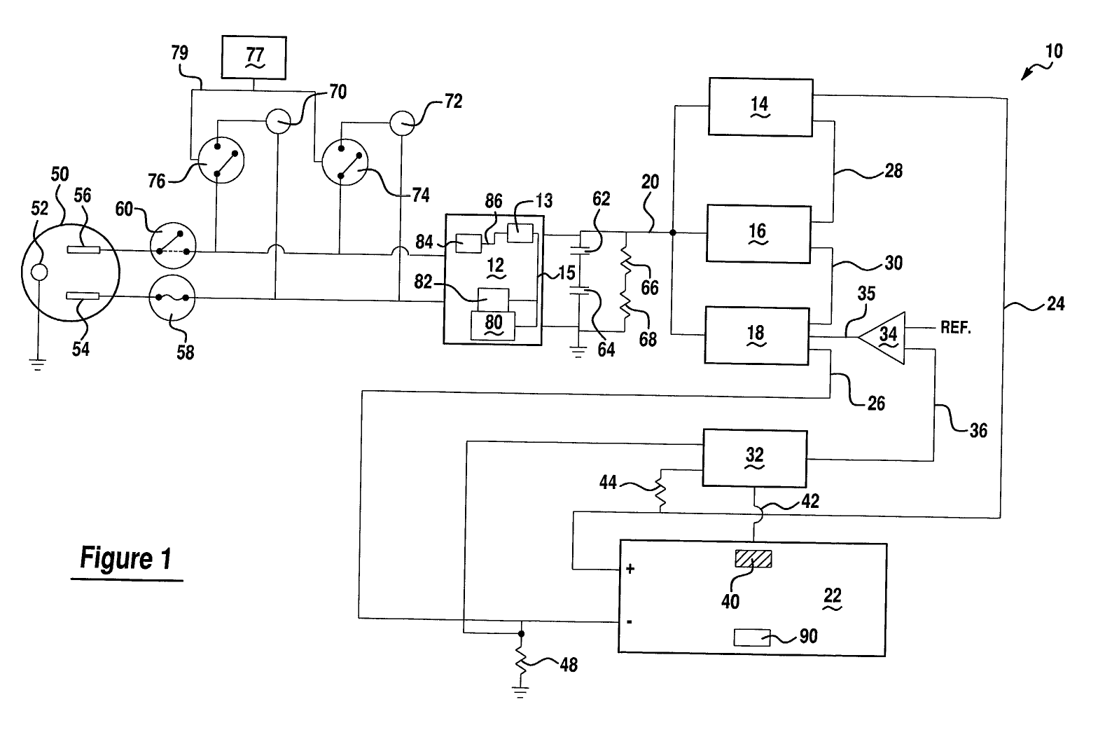

Referring now to FIG. 1, there is shown a charger assembly 10 which is made in accordance with the teachings of the preferred embodiment of the invention. As shown, charger assembly 10 includes an input module 12 which may, in one non-limiting embodiment, include a processor 13 operating under stored program control, and substantially identical direct current to direct current converters 14, 16, and 18 which are physically and communicatively coupled to the input module by bus 20. Converter 14 is selectively, removably, physically, and communicatively coupled to the positive terminal of the battery assembly 22 by use of bus 24 and converter 18 is selectively, removably, physically, and communicatively coupled to the negative terminal of the battery assembly 22 by bus 26. Converter 14 is selectively, removably, physically and communicatively coupled to converter 16 by use of bus 28 and converter 16 is selectively, removably, physically, and communicatively coupled to the converter 18 by use of bus 30. In one non-limiting embodiment of the invention, each converter 14, 16, and 18 comprises a model PD300-300-48PC converter sold and/or produced by the Powercube Corporation. Other types of converters may be utilized. Module 12 may also include a memory module 80 and a transmitter and receiver or global communications network interface module 82 which are each physically, electrically and communicatively coupled to the processor 13 by use of bus 15. Module 82 may comprise a radio frequency type transceiver, a power line carrier transceiver, or an Internet type interface.

The charger assembly 10 further includes a signal summation circuit member 32 which is physically and communicatively coupled to a signal comparator 34 by bus 36. The signal comparator 34 is selectively, removably, physically, and communicatively coupled to converter 18 by use of bus 35 and receives and/or stores a reference signal of a certain threshold value. Summation circuit member 32 is selectively, removably, physically, and communicatively coupled to a temperature sensor 40 by use of bus 42. In the preferred embodiment of the invention, the temperature sensor 40 is resident within the battery assembly 22 and accurately and periodically “reads” or determines the temperature within the battery assembly 22 and periodically provides and/or communicates this temperature information to the summation circuit member 32 by use of bus 42.

Charger assembly 10 further includes a first resistor 44 which is selectively, removably, physically, and communicatively coupled to the battery assembly 22 by use of bus 24 and to the summation circuit member 32 which couples the resistor 44 to a source of an electrical ground potential. In one non-limiting embodiment of the invention the resistor 44 has an electrical resistance value of about 0.1 ohms, although other resistance values may be used. In this manner, the voltage appearing “across” the resistor 44 is substantially representative of the voltage which is communicated to the battery assembly 22 by the charger assembly 10. This voltage is periodically “read” by the summation circuit 32 and used in the “trimming” operation which is more fully delineated below.

Charger assembly 10 further includes a second resistor 48 which is physically and electrically coupled to a source of electrical ground potential and which is further physically and electrically coupled to bus 26 and to the summation circuit member 32. In one non-limiting embodiment of the invention, resistor 48 has a resistance value of about 0.1 ohms although other values may be used. In this manner, the electrical current flowing through resistor 48 is substantially representative of and/or substantially equal to the amount of current which is provided to and/or communicated to the battery assembly 22 by the charger assembly 10. This amount of electrical current is periodically measured and communicated to the summation circuit assembly 22 for use in the “trim” operation which is more fully delineated below.

As is further shown in FIG. 1, charger assembly 10 includes a conventional balanced “plug” or interface member 50 having three substantially identical protrusions 52, 54, and 56 which are adapted to cooperatively allow the member 50 to be selectively and removably inserted into a conventional electrical power outlet or “wall plug” (not shown) and to receive electrical power (i.e., electrical voltage and current or charge) from such an electrical power outlet.

The protrusion 52 is typically physically and electrically coupled to a source of electrical ground potential while protrusion 56 is physically and communicatively coupled to a fuse 58. In one non-limiting embodiment of the invention, fuse 58 is of the “20-ampere” type, although other fuses may be used. As should be appreciated by those of ordinary skill in the art, fuse 58 protects charger assembly 10 from relatively “high power” spikes which are communicated to the fuse 58 by the member 50 and which emanate from the electrical power wall outlet (not shown). Protrusion 56 is physically and electrically coupled to a switch 60 which is selectively moved between a first open position and a second closed position (shown in phantom in FIG. 1). Switch 60 and fuse 58 are physically and electrically coupled to the input module member 12 and selectively and cooperatively communicate the electrical power received by the member 50 to the module 12. In one non-limiting embodiment of the invention, module 12 includes a commercially available model number UFM1K autoranging rectifier module which is sold and/or produced by the Powercube Corporation and which rectifies or converts the received electrical voltage to a direct current type of voltage.

The input module 12 is physically and electrically coupled to a pair of capacitors 62, 64 which are coupled or mutually configured in an electrical series arrangement. In one non-limiting embodiment of the invention, each of the capacitors 62, 64 is substantially identical and each capacitor 62, 64 comprises or commercially available “ESR” type high temperature aluminum electrolytic capacitor having a capacitance value of about 1500 micro-faruds. Capacitor 64 is further physically and electrically coupled to a source of electrical ground potential. Capacitor 62 is physically, electrically, and communicatively coupled to bus 20. Charger assembly 10 further includes a third resistor 66 and a fourth resistor 68 which are connected or mutually configured in an electrical series arrangement. Resistor 68 is physically, communicatively, and electrically coupled to a source of electrical ground potential and resistor 66 is physically, electrically, and communicatively coupled to capacitor 62 and to bus 20.

In operation, member 50 is selectively inserted into a conventional electrical power outlet or “wall plug” (not shown). Switch 60 is selectively moved to a closed position and electrical power (i.e. electrical voltage and electrical current or charge) is communicated to the input module 12 from the electrical power wall outlet (not shown) and through the cooperative arrangement of switch 60 and fuse 58. The received electrical power is rectified by and communicated by module 12 to the capacitors 62, 64 where it is temporally stored until used. The capacitors 62, 64 cooperatively allow diverse types of electrical power to be communicated to and allows the charger assembly 10 the input module 12 and allow the charger assembly 10 to have a relatively wide applicability and use within a relatively wide variety of electrical power environments. That is, direct current type of received electrical voltage may be directly communicated, for storage, to the capacitors 62, 64 through the module 12, while an alternating type of received voltage is first rectified by module 12 before being communicated to the capacitors 62, 64. Module 12 (i.e., processor 13) automatically recognizes the type and amount of the received electrical voltage and either causes it to be rectified to a certain level required by the capacitors 62, 64 or the received voltage to be directly communicated, without rectifications to the capacitors 62, 64, is the previously delineated manner. Processor 13 may also selectively “pad” or reduce the amplitude of direct current type voltage before communicating the received voltage to the capacitors 62, 64 in the event that the amount of received voltage exceeds the current storage capacity of the capacitors 62, 64.

Typically the electrical voltage which is communicated to the input module 12 is of the alternating current type and has a root mean square voltage value of about 90 to about 250 volts. The input module, in this one non-limiting embodiment, provides and/or communicates about 300 volts of direct current type voltage upon bus 20 to the capacitors 62, 64. The stored electrical power is provided to the converters 14, 16, 18 by use of resistors 66, 68. Converters 14, 16, and 18 which, in one non-limiting embodiment of the invention, are “synchronized in phase” cooperatively provide as is more fully delineated below, a single, isolated, regulated, and protected and “dynamically modifiable” output of electrical power to the battery assembly 22, effective to allow the battery assembly 22 to be substantially and fully charged while concomitantly reducing the likelihood of overcharging. The amount of provided electrical power is regulated or dynamically modifiable by use of a “trimming control” signal which is placed onto bus 35 by the comparator 34 as is more fully delineated below and may be made substantially constant and independent of the type or amount of changes while occur to the signal emanating from the wall plug outlet.

That is, about eight ampere, of electrical current is typically provided to the battery assembly 22 in order to initially charge a substantially and previously discharged battery assembly 22. The initially “sourced” or provided voltage is varied depending upon the temperature output signal from the sensor 40. That is, in one non-limiting embodiment of the invention, if the sensed temperature is equal to or less than about zero degrees centigrade, the voltage which is communicated to the battery assembly 22 is made to equal about 152.8 volts of direct current type voltage. If the sensed temperature is equal to about twenty degrees centigrade, the voltage which is communicated to the battery assembly 22 is made to equal about 148 volts of direct current type voltage. If the sensed temperature is equal to about seventy degrees centigrade, the voltage which is communicated to the battery assembly 22 is made to equal about 136 volts of direct current. If the sensed temperature is between zero degrees centigrade and twenty degrees centigrade, the voltage which is communicated to the battery assembly 22 is made substantially equal an amount which is equal to the difference between 142.8 and a second number. The second number is equal to the product of 4.2 and a fraction having a numerator equal to the currently sensed temperature and a denominator equal to twenty. If the sensed temperature is between about twenty degrees centigrade and about seventy degrees centigrade, the voltage which is communicated to the battery assembly 22 is made substantially equal to the difference between 138 and a third number. The third number is equal to the product of 12 and a second fraction having a numerator equal to the currently sensed temperature and a denominator equal to about fifty. If the temperature is over about ninety degrees centigrade, no electrical power is provided and/or communicated to the battery assembly 22. If the temperature is between about seventy degrees centigrade and about ninety degrees centigrade, the voltage which is communicated to the battery assembly 22 is made substantially equal to the difference between 126 and a fourth number. The fourth number is equal to the product of 21 and a third fraction having a numerator equal to the currently sensed temperature and a denominator equal to about twenty. In this manner, the provided electrical power is automatically and “temperature” regulated according to the measured temperature of the battery assembly 22, thereby reducing the likelihood of battery overcharge and undesirable battery damage.

Fans, such as fans 70, 72 may be placed within the charger assembly 10 and selectively and physically, and electrically coupled to busses 74, 76 by the selective activation of respective switches 74,76 by the input module 12 or by a thermostat 77 (i.e. a device to monitor the temperature of the charger assembly 10 and to provide a first output signal onto bus 79 should the temperature exceed a first dynamically configurable value and to provide a second signal onto bus 79 should the temperature fall below a second dynamically configurable value) in order to cool the charger assembly 10 should the monitored temperature of the charger assembly 10 exceed over seventy degrees centigrade. These fans 70, 72 may be selectively deactivated (i.e. respective switches 74, 76 may be physically and electrically opened) should the temperature within the battery charger 10 fall below about sixty degrees centigrade (i.e., the first signal from thermostat 77 “closes” switches 74, 76 and the second signal “opens” these switches 74, 76).

After the initial amount of electrical power begins to be communicated to the battery assembly 22, the supplied electrical voltage and current is “read” or periodically monitored in the manner which has been previously delineated. The monitored amount of supplied electrical voltage, the monitored temperature within the battery assembly 22, and the monitored amount of supplied electrical current are summed and compared with the value of the reference signal by comparator 34. Should the summation of these three received signals exceed the value of the reference signal, a signal is produced on bus 35 and communicated to the converter 18, effective to dynamically modify or dynamically and automatically reduce the amount of supplied voltage and current or electrical charge to the battery assembly 22, thereby substantially preventing undesired overcharging and outgassing from occurring. In one non-limiting embodiment of the invention, a substantially constant charging voltage is supplied until the periodically monitored and sensed electrical current “drops” or falls below about two amperes. By way of example and without limitation, should the battery assembly 22 contain about sixty separate battery cells (although other numbers of battery cells are possible), a charging voltage of about 148 volts is communicated by the charger assembly 10 to the battery assembly 22. At a sensed battery assembly temperature of about twenty degrees centigrade, the supplied charging current is made to equal about eight amperes. Should the sensed or monitored amount of charging current drop to about two amperes, the summed signal will fall below the reference signal and the signal on bus 35 will cause the communicated voltage to be automatically reduced to about 138 volts or about 2.3 volts per cell at about twenty degrees centigrade, thereby automatically providing a “float” type charge and substantially preventing or substantially reducing the likelihood of battery discharge.

Alternatively, the input module 12 contains a timer 84 which is coupled to processor 13 by bus 86 and which begins to operate upon the occurrence of such a “drop” of charging current. Once a predetermined interval of time has lapsed (i.e. about four hours), the module 12 may cause the battery assembly 22 to be “recharged” in the foregoing manner provided that the charger assembly 10 be connected to the battery assembly 22 in the manner shown and previously described with respect to FIG. 1. Alternatively, memory module 82 may be selectively provided with the identity and charging time of battery assembly 22 by use of a transmitter 90 which is resident within the battery assembly 22 and which is of the radio frequency, or a power line carrier, or global communications network type), thereby enabling the transmitter to store identifications and timing data and to communicate with the interface 82, thereby enabling the charger assembly 10 to be used with other battery assemblies while “remembering” or automatically notifying a user of the lapse of the predetermined time interval and the need to “re-charge” the battery assembly 22.

Global communications network interface module or Internet interface module 82, allows the contents of the memory 82 to be selectively accessed by computers, individuals, and/or entities which are remotely located from the charger assembly 10, thereby allowing a user or remotely located computer to dynamically acquire historical data associated with the use of the charger assembly 10 (i.e., the identity of all of the battery assemblies 22 unit have been charged together with all of the respective charge levels, charging time, and the time that the assemblies were respectively charged).

It is to be understood that the invention is not to be limited to the exact construction and method which has been illustrated and discussed above but that various changes may be made without departing from the spirit and the scope of the inventions as described within the following claims. It should be further realized that charger assembly 22 is relatively compact, inexpensive, and uncomplicated architectural design and that charger assembly 22 obviates the need for a user to “remember” to utilize the assembly 22 only with a certain type of received voltage and/or power signal.

What is claimed is:

1. A charger assembly which provides a first amount of electrical power and which automatically reduces said provided first amount of electrical power by a certain amount.

2. The charger assembly of claim 1 wherein said certain amount is based upon said first amount of electrical power.

3. The charger assembly of claim 2 wherein said first amount of electrical power is produced by use of a first voltage and a first current and wherein said first amount of said electrical power is reduced by said certain amount when said first current is below a certain value.

4. The charger assembly of claim 3 wherein said certain value is about two amperes.

5. The charger assembly of claim 4 wherein said first voltage has a value of about 138 volts when said electrical power is reduced by said certain amount.

6. The charger assembly of claim 1 wherein said charger assembly includes a timer; and a memory.

7. The charger assembly of claim 6 wherein said timer causes said charger assembly to provide said battery assembly said first amount of electrical power after a certain time period has elapsed since said first amount of electrical power was reduced by said certain amount.

8. The charger assembly of claim 7 wherein said memory selectively stores data identifying said battery assembly.

9. The charger assembly of claim 8 further comprising a global communications network interface which allows said data to be accessed by a computer which is remotely placed from said charger assembly.

10. A charger assembly which communicates voltage to a battery assembly and which dynamically modifies said voltage to substantially reduce the likelihood of overcharging said battery assembly.

11. The charger assembly of claim 10 under said charger assembly provides an amount of electrical current to said battery assembly and when said voltage is reduced when said amount of said electrical current is of a certain value.

12. The charger assembly if claim 10 when said charger assembly provides an amount of electrical voltage to said battery assembly and when said voltage is reduced when said amount of said electrical voltage is of a certain value.

13. The charger assembly if claim 10 when said charger assembly h as a temperature of a certain value and when said voltage is reduced based upon said certain value.

14. The charger assembly of claim 10 when said charger assembly receives a plurality of types of voltage and when said charger assembly communicates each of said plurality of said types of said voltage to said battery assembly.

15. The charger assembly of claim 10 further comprising a first member resident within said battery assembly; and a second member resident within said charger assembly which communicates with said first member.

16. The charger assembly of claim 15 when said first member comprises a radio frequency transmitter.

17. The charger assembly of claim 15 when said first and second members communicate by use of a power lane carrier.

18. A method for charging a battery assembly having a certain temperature, said method comprising the steps of:
charging said battery assembly by providing voltage and current to said battery assembly;
monitoring said voltage, currents and a temperature of said battery assembly;
adding said monitored temperatures, said monitored voltage and said monitored current to produce a value; and
completing said charging of said battery assembly when said value exceeds a certain number.

19. The method of claim 18 further comprising the step of automatically charging said battery assembly after a certain period of time has elapsed after said charging was completed.

20. The method of claim 18 further comprises the step of providing a float charge after completing said charging of said battery assembly.
